(19) United States
(12) Patent Application Publication
(10) Pub. No.: US 2023/0397294 A1
(43) Pub. Date: Dec. 7, 2023

(54) METHODS, SYSTEMS, AND DEVICES FOR PERFORMING A DISCONTINUOUS RECEPTION OPERATION FOR RADIO LINK FAILURE AND BEAM FAILURE

(71) Applicant: ZTE CORPORATION, Shenzhen (CN)

(72) Inventors: Fei DONG, Shenzhen (CN); He HUANG, Shenzhen (CN)

(73) Assignee: ZTE CORPORATION, Shenzhen (CN)

(21) Appl. No.: 18/237,005

(22) Filed: Aug. 23, 2023

Related U.S. Application Data
(63) Continuation of application No. PCT/CN2021/099573, filed on Jun. 11, 2021.

(51) Int. Cl. H04W 76/28; H04W 76/19

(52) U.S. Cl. CPC H04W 76/28; H04W 76/19

(57) ABSTRACT

The present disclosure relates to to methods, systems, and devices for performing a discontinuous reception operation for radio link failure and beam failure. In some forms, a method for wireless communication includes user equipment detecting a beam failure tendency for a serving cell of one discontinuous reception (DRX) group or a radio link failure tendency for the serving cell of one DRX group, and in response, either suspending the discontinuous reception operation at the user equipment or adjusting, with the processor, a duration of a subsequent discontinuous reception cycle for the DRX group that the serving cell belongs to. By aborting a currently configured DRX operation or shortening a duration of subsequent DRX cycles, the user equipment is able to more quickly recover from a beam failure or a radio link failure.

### TECHNICAL FIELD

This document is generally directed to wireless communications.

### BACKGROUND

In 5G NR, discontinuous reception (DRX) is an efficient way to provide user equipment (UE) power savings while the user equipment operates in a connected mode because the user equipment only needs to periodically wake up to monitor signals from network elements. However, the efficiency in power savings can come at a cost of a delay in signaling transmission between the user equipment and other network elements.

For normal data exchanges between network elements and user equipment, the delay in signaling transmission may not present issues because the network elements can configure an optimal DRX that is configured to the user equipment based on a quality of service (QoS) requirement of a currently established QoS flow at the user equipment side. However, for some events such as beam failure recovery (BFR) or radio link failure (RLF), a DRX working mechanism may reduce a time for user equipment to react to the beam failure or radio link failure. The reason for this is that while the beam failure or radio link failure is occurring, user equipment may not be aware of the failure in time according to when a current beam failure detection (BFD) and/or radio link failure detection (RLD) mechanism occurs in conjunction with a DRX period. Accordingly, it is desirable to develop new methods that provide user equipment the ability to better react to beam failures and/or radio link failures while performing discontinuous reception operations.

### SUMMARY

This document relates to methods, systems, and devices for performing a discontinuous receiption operation for radio linked failure and beam failure.

In some implementations, a method for wireless communication includes: detecting, with a processor of user equipment, a beam failure tendency for a serving cell of one discontinuous reception (DRX) group or a radio link failure tendency for the serving cell of one DRX group; and adjusting, with the processor, a duration of a subsequent discontinuous reception cycle for the DRX group that the serving cell belong to after the detection of the beam failure tendency or the radio link failure tendency.

In some other implementations, a wireless communication apparatus comprises a processor and a memory, wherein the processor is configured to read code from the memory and implement a method as recited above.

In yet other implementations, a computer program product comprises a computer-readable program medium code stored thereupon, the code, when executed by a processor, causing the processor to implement a method as recited above.

In some other implementations, a method for wireless communication includes: detecting, with a processor of user equipment, a beam failure tendency for a serving cell of one discontinuous reception (DRX) group or a radio link failure tendency for the serving cell of one DRX group; and suspending, with the processor, a DRX operation for the DRX group that the serving cell belongs to after the detection of the beam failure tendency or the radio link failure tendency.

In some other implementations, a wireless communication apparatus comprises a processor and a memory, wherein the processor is configured to read code from the memory and implement a method as recited above.

In yet other implementations, a computer program product comprises a computer-readable program medium code stored thereupon, the code, when executed by a processor, causing the processor to implement a method as recited above.

The above and other aspects and their implementations are described in greater detail in the drawings, the descriptions, and the claims.

### BRIEF DESCRIPTION OF THE DRAWINGS

FIG. 1 shows an example of a wireless communication system.

FIG. 2 shows example layers of a communication node of the wireless communication system of FIG. 1.

FIG. 3 illustrates an example discontinuous receiption cycle 300

FIG. 4 is a flow chart of one implementation of a method for user equipment automatically suspending a DRX operation for beam failure recovery.

FIG. 5 is a flow chart of another implementation of a method for user equipment automatically suspending a DRX operation for beam failure recovery.

FIG. 6 is a flow chart of one implementation of a method for user equipment automatically utilizing a short DRX period after a beam failure tendency is detected.

FIG. 7 is a flow chart of another implementation of a method for user equipment automatically utilizing a short DRX period after a beam failure tendency is detected.

FIG. 8 is a flow chart of one implementation of a method for user equipment automatically suspending a DRX operation after a radio link failure tendency is detected.

FIG. 9 is a flow chart of one implementation of a method for user equipment automatically utilizing a short DRX period after a radio link failure tendency is detected.

FIG. 10 is a flow chart of another implementation of a method for user equipment automatically utilizing a short DRX period after a radio link failure tendency is detected.

### DETAILED DESCRIPTION

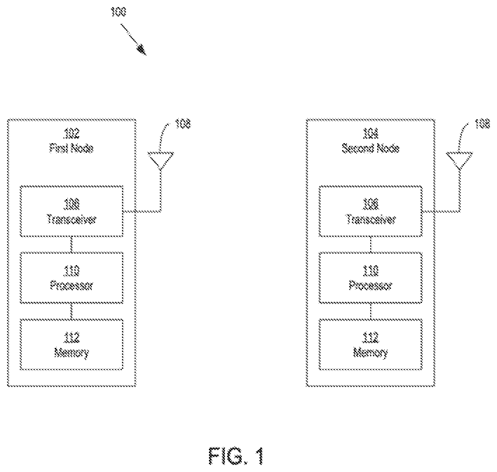

The present disclosure relates to methods, systems, and devices for performing a discontinuous receiption operation for radio link failure and beam failure. FIG. 1 shows a diagram of an example wireless communication system 100 where discontinuous receiption operations for radio link failure and beam failure may be implemented. In one form, the wireless communication system 100 includes a plurality of communication nodes that are configured to wirelessly communicate with each other. The communication nodes include a first node 102 and a second node 104. Various other examples of the wireless communication system 100 may include more than two communication nodes.

In general, each communication node is an electronic device, or a plurality (or network or combination) of electronic devices, that is configured to wirelessly communicate with another node in the wireless communication system, including wirelessly transmitting and receiving signals. In various implementations, each communication node may be one of a plurality of types of communication nodes.

One type of communication node is a user device. A user device may include a single electronic device or apparatus, or multiple (e.g., a network of) electronic devices or apparatuses, capable of communicating wirelessly over a network. A user device may include or otherwise be referred to as a user terminal or a user equipment (UE). Additionally, a user device may be or include, but not limited to, a mobile device (such as a mobile phone, a smart phone, a tablet, or a laptop computer, as non-limiting examples) or a fixed or stationary device, (such as a desktop computer or other computing devices that are not ordinarily moved for long periods of time, such as appliances, other relatively heavy devices including Internet of things (IoT), or computing devices used in commercial or industrial environments, as non-limiting examples).

A second type of communication node is a wireless access node. A wireless access node may comprise one or more base stations or other wireless network access points capable of communicating wirelessly over a network with one or more user devices and/or with one or more other wireless access nodes. For example, the wireless access node 104 may comprise a 4G LTE base station, a 5G NR base station, a 5G central-unit base station, a 5G distributed-unit base station, a next generation Node B (gNB), an enhanced Node B (eNB), or other base station, or network in various embodiments.

As shown in FIG. 1, each communication node 102, 104 may include transceiver circuitry 106 coupled to an antenna 108 to effect wireless communication. The transceiver circuitry 106 may also be coupled to a processor 110, which may also be coupled to a memory 112 or other storage device. The processor 110 may be configured in hardware (e.g., digital logic circuitry, field programmable gate arrays (FPGA), application specific integrated circuits (ASIC), or the like), and/or a combination of hardware and software (e.g., hardware circuitry (such as a central processing unit (CPU)) configured to execute computer code in the form of software and/or firmware to carry out functions). The memory 112, which may be in the form of volatile memory, non-volatile memory, combinations thereof, or other types of memory, may be implemented in hardware, and may store therein instructions or code that, when read and executed by the processor 110, cause the processor 110 to implement various functions and/or methods described herein. Also, in various implementations, the antenna 108 may include a plurality of antenna elements that may each have an associated phase and/or amplitude that can be controlled and/or adjusted, such as by the processor 110. Through this control, a communication node may be configured to have transmit-side directivity and/or receive-side directivity, in that the processor 110, and/or the transceiver circuitry 106, can perform beam forming by selecting a beam from among a plurality of possible beams, and transmit or receive a signal with the antenna radiating the selected beam.

Additionally, in various implementations, the communication nodes 102, 104 may be configured to wirelessly communicate with each other in or over a mobile network and/or a wireless access network according to one or more standards and/or specifications. In general, the standards and/or specifications may define the rules or procedures under which communication nodes 102, 104 can wirelessly communicate, which may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

In the wireless system 100, the communication nodes 102, 104 are configured to wirelessly communicate signals between each other. In general, a communication in the wireless system 100 between two communication nodes can be or include a transmission or a reception, and is generally both simultaneously, depending on the perspective of a particular node in the communication. For example, for a communication between the first node 102 and the second node 104, where the first node 102 is transmitting a signal to the second node 104 and the second node 104 is receiving the signal from the first node 102, the communication may be considered a transmission for the first node 102 and a reception for the second node 104. Similarly, where the second node 104 is transmitting a signal to the first node 102 and the first node 102 is receiving the signal from the second node 102, the communication may be considered a transmission for the second node 104 and a reception for the first node 102. Accordingly, depending on the type of communication and the perspective of a particular node, when a first node is communicating a signal with a second node, the node is either transmitting the signal or receiving the signal. Hereafter, for simplicity, communications between two nodes are generally referred to as transmissions.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, particular signals can be characterized or defined as either an uplink (UL) signal or a downlink (DL) signal. An uplink signal is a signal transmitted from a user device to the wireless access node. A downlink signal is a signal transmitted from a wireless access node to a user device. Also, certain signals may defined or characterized by combinations of data/control and uplink/downlink, including uplink control signals, uplink data signals, downlink control signals, and downlink data signals.

For at least some specifications, such as 5G NR, an uplink control signal is also referred to as a physical uplink control channel (PUCCH), an uplink data signal is also referred to as a physical uplink shared channel (PUSCH), a downlink control signal is also referred to as a physical downlink control channel (PDCCH), and a downlink data signal is also referred to as a physical downlink shared channel (PDSCH).

Also, some signals communicated in the system 100 may be defined or characterized as reference signals (RS). In general, a reference signal may be recognized in the system 100 as a signal other than a shared channel signal or a control signal, although a reference signal may be an uplink reference signal or a downlink reference signal. Non-limiting examples of reference signals used herein, and as defined at least in 5G NR, include a demodulation reference signal (DM-RS), a channel-state information reference signal (CSI-RS), and a sounding reference signal (SRS). A DM-RS is used for channel estimation to allow for coherent demodulation. For example, a DMRS for a PUSCH transmission allows a wireless access node to coherently demodulate the uplink shared channel signal. A CSI-RS is a downlink reference signal used by a user device to acquire downlink channel state information (CSI). A SRS is an uplink reference signal transmitted by a user device and used by a wireless access node for uplink channel-state estimation.

Additionally, a signal may have an associated resource that, in general, provides or identifies time and/or frequency characteristics for transmission of the signal. An example time characteristic is a temporal positioning of a smaller time unit over which the signal spans, or that the signal occupies, within a larger time unit. In certain transmission schemes, such as orthogonal frequency-division multiplexing (OFDM), a time unit can be a sub-symbol (e.g., a OFDM sub-symbol), a symbol (e.g., a OFDM symbol), a slot, a sub-frame, a frame, or a transmission occasion. An example frequency characteristic is a frequency band or a sub-carrier in or over which the signal is carried. Accordingly, as an example illustration, for a signal spanning N symbols, a resource for the signal may identify a positioning of the N symbols within a larger time unit (such as a slot) and a subcarrier in or over which the signal is carried.

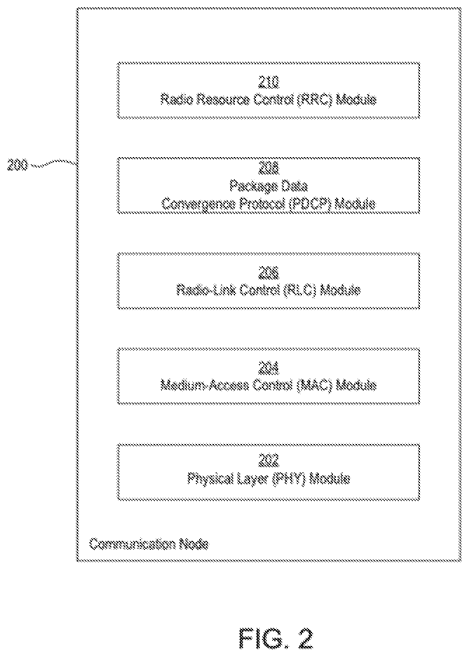

FIG. 2 shows a block diagram of a plurality of modules of a communication node 200, including a physical layer (PHY) module 202, a medium-access control (MAC) module 204, a radio-a link control (RLC) module 206, a package data convergence protocol (PDCP) module 208, and a radio resource control (RRC) module 210. In general, as used herein, a module is an electronic device, such as electronic circuit, that includes hardware or a combination of hardware and software. In various implementations, a module may be considered part of, or a component of, or implemented using one or more of the components of a communication node of FIG. 1, including a processor 110, a memory 112, a transceiver circuit 106, or the antenna 108. For example, the processor 110, such as when executing computer code stored in the memory 112, may perform the functions of a module. Additionally, in various implementations, the functions that a module performs may be defined by one or more standards or protocols, such as 5G NR for example. In various embodiments, the PHY module 202, the MAC module 204, the RLC module 206, the PDCP module 208, and RRC module 210 may be, or the functions that they perform may be, part of a plurality of protocol layers (or just layers) into which various functions of the communication node are organized and/or defined. Also, in various embodiments, among the five modules 202-210 in FIG. 2, the PHY module 202 may be or correspond to the lowest layer, the MAC module 204 may be or correspond to the second-lowest layer (higher than the PHY module 202), the RLC module 206 may be or correspond to the third lowest layer (higher than the PHY module 202 and the MAC module 204), the PDCP module 208 may be or correspond to the fourth-lowest layer (higher than the PHY module 202, the MAC module 204, and the RLC module 206), and the RRC module 210 may be or correspond to the fifth lowest layer (higher than the PHY module, the MAC module 204, the RLC module 206, and the PDCP module 208). Various other implementations may include more or fewer than the five modules 202-210 shown in FIG. 2, and/or modules and/or protocol layers other than those shown in FIG. 2.

The modules of a communication node shown in FIG. 2 may perform various functions and communicate with each other, such as by communicating signals or messages between each other, in order for the communication node to send and receive signals. The PHY layer module 202 may perform various functions related to encoding, decoding, modulation, demodulation, multi-antenna mapping, as well as other functions typically performed by a physical layer.

The MAC module 204 may perform or handle logical-channel multiplexing and demultiplexing, hybrid automatic repeat request (HARQ) retransmissions, and scheduling-related functions, including the assignment of uplink and downlink resources in both the frequency domain and the time domain. Additionally, the MAC module 204 may determine transport formats specifying how a transport block is to be transmitted. A transport format may specify a transport-block size, a coding and modulation mode, and antenna mapping. By varying the parameters of the transport format, the MAC module 204 can effect different data rates. The MAC module 204 may also control distributing data from flows across different component carriers or cells for carrier aggregation.

The RLC module 206 may perform segmentation of service data units (SDU) to suitably sized protocol data units (PDU). In various implementations, a data entity from/to a higher protocol layer or module is called a SDU, and the corresponding data entity to/from a lower protocol layer or module is called a PDU. The RLC module 206 may also perform retransmission management that involves monitoring sequence numbers in PDUs in order to identify missing PDUs. Additionally, the RLC module 206 may communicate status reports to enable retransmission of missing PDUs. The RLC module 206 may also be configured to identify errors due to noise or channel variations.

The package data convergence protocol module 208 may perform functions including, but not limited to, Internet Protocol (IP) header compression and decompression, ciphering and deciphering, integrity protection, retransmission management, in-sequence delivery, duplicate removal, dual connectivity, and handover functions.

The RRC module 210 may be considered one of one or more control-plane protocol responsible for connection setup, mobility, and security. The RRC module 210 may perform various functions related to RAN-related control-plane functions, including broadcast of system information; transmission of paging messages; connection management, including setting up bearers and mobility; cell selection, measurement configuration and reporting; and handling device capabilities. In various embodiments, a communication node may communicate RRC messages using signaling radio bearers (SRBs) according to protocols defined by one or more of the other modules 202-210.

Various other functions of one or more of the other modules 202-210 may be possible in any of various implementations.

As discussed above, discontinuous receiption (DRX) is an efficient way to provide user equipment (UE) power savings while operating in a connected mode because the user equipment only needs to periodically wake to monitor signals from network elements. However, the efficiency in power savings can come at a cost of a delay in signaling transmission between the user equipment and other network elements.

For normal data exchanges between network elements and user equipment, the delay in signaling transmission may not present issues because the network elements can configure an optimal DRX configured to the user equipment based on a quality of service (QoS) requirement of a currently established QoS flow at the user equipment side. However, for some events such as beam failure recovery (BFR) or radio link failure (RLF), a DRX working mechanism may reduce a time for user equipment to react to the beam failure or radio link failure. The reason for this is that while the beam failure or radio link failure is occurring, the user equipment may not be aware of the failure in time according to when a current beam failure detection (BFD) and/or radio link failure detection (RLD) mechanism occur in conjunction with a DRC period.

Table 1 illustrates how monitoring of a synchronization signal block (SSB) for radio link failure detection and/or beam failure detection may be delayed by a DRX period.

TABLE 1
Evaluation period T_{Evaluate}_{_{—}}ₒᵤₜ_{_{—}}_{SSB} and T_{Evaluate}_{_{—}}ᵢₙ_{_{—}}_{SSB} for FR1

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × P) × T_{SSB}) | Max(100, Ceil(5 × P) × T_{SSB}) |
| DRX cycle ≤ | Max(200, Ceil(15 × P) × | Max(100, Ceil(7.5 × P) × |
| 320 ms | Max(T_{DRX}, T_{SSB})) | Max(T_{DRX}, T_{SSB})) |
| DRX cycle > | Ceil(10 × P) × T_{DRX} | Ceil(5 × P) × T_{DRX} |
| 320 ms | | |

In Table 1, TSSB is a periodicity of the SSB configured for radio link monitoring (RLM) and TDRX is a DRX cycle length. As shown in Table 1, a radio link monitoring period is dependent on the DRX cycle length, and the larger DRX cycle length is, the larger radio link monitoring period is.

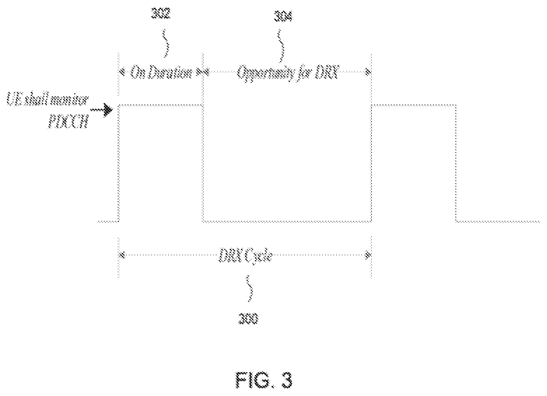

Referring to FIG. 3, FIG. 3 illustrates an example DRX cycle 300. The DRX cycle 300 can be dynamically changed between the Long DRX cycle and the short DRX cycle if the short DRX cycle is configured. Each DRX cycle 300 includes an on duration portion 302 and an opportunity portion 304. During the on duration portion 202, the user equipment is in an active status. During the opportunity portion 304, the user equipment is in a sleep mode status. Since the user equipment may only perform actions such as monitoring a physical downlink control channel (PDCCH) during the on duration portion 302, it will be appreciated that if there is beam failure or radio link failure during the opportunity portion 304, there will be a delay in the user equipment becoming aware of the failure and a delay in the user equipment completing procedures to recover from the beam failure or radio link failure. In some implementations, a MAC module of a user equipment may be configured with more than one DRX group, where one DRX group may comprise of one or multiple serving cells and the user equipment may perform the different DRX operation for the serving cells within the different DRX groups. In some implementations, the MAC module of a user equipment may be configured with only one DRX group, where all the serving cells belong to the MAC module using the unified DRX operation.

To address the issues described above, the present disclosure provides implementations where user equipment is able to reduce a duration of a DRX cycle or suspend a DRX operation for one or more serving cells when a beam failure tendency or a radio link failure tendency is detected for one or more serving cells in order to more quickly recover from the failure. While illustrative examples are provided below, generally, when user equipment is operating in DRX and at least one of the tendency of a beam failure or the tendency of a radio link failure is detected for one or more serving cells configured with DRX operation in one DRX group, the user equipment may suspend the DRX operation for one or more serving cells in one DRX group.

Alternatively, the user equipment may decrease a duration of the DRX cycle for one DRX group where the beam failure tendency and radio link failure tendency for the serving cells is detected, thereby reducing the period of time where the user equipment is in a sleep state. When the user equipment decreases a duration of the DRX cycle, the user equipment may shorten the currently configured DRX cycle or apply a new short DRX cycle to the DRX group having a duration that is shorter duration than a previous DRX cycle or the long DRX cycle. By suspending a currently configured DRX operation or shortening a duration of subsequent DRX cycles, the user equipment is able to more quickly detect the tendency of beam failure or radio link failure and recover from a beam failure or a radio link failure for one or more serving cells.

Further, while illustrative examples are provided below, in some implementations, the user equipment may determine a tendency of beam failure has been detected for one or more serving cells in one DRX group, or a radio link failure tendency has been detected for one or more serving cells in one DRX group based on one or more consecutive indications for one or more serving cells received at a MAC layer of the user equipment from a lower protocol layer such as a PHY layer of the user equipment.

Further, in some implementations regarding beam failure tendency detection for one serving cell, the beam failure tendency for one serving cell is detected by the following event: the MAC layer receiving n or more than n consecutive indications for one specific serving cell from the PHY layer.

Further, in some implementations regarding beam failure tendency detection of one DRX group, the suspension of a DRX operation or shortening a duration of subsequent DRX cycles for one or more serving cells in one DRX group can be triggered by at least one of the following events: (1) there is at least one serving cell in the DRX group where the beam failure tendency is detected; (2) the MAC layer receives n or more than n consecutive indications for all serving cells that are in one DRX group from the PHY layer; or (3) beam failure tendency is detected for m or more than m serving cells.

The parameters n and m mentioned above may be configured via radio resource control (RRC) signaling, downlink control information (DCI), medium-access control element (MAC CE) signaling, or may be predefined via specification. In some implementations of the indication for beam failure tendency, the indications for detecting the tendency of beam failure may be generated in the PHY layer upon a measured result of the configured reference signals, where these indications may indicate the beam failure tendency for one specific cell or one set of serving cells those are configured with the DRX operation in one DRX group.

Further, for the case of radio link failures, in some implementations, the suspension of a DRX operation or shortening a duration of subsequent DRX cycles for one or more serving cells in one DRX group can be triggered by at least one of the following events: (1) n or more than n consecutive indications for one serving cell in a DRX group are received at the MAC layer from the PHY layer. Specifically, this serving cell may be a primary cell or one secondary cell which is configured for the DRX operation. (2) n or more than n consecutive indications for all serving cells in one DRX group are received by the MAC layer from PHY layer. (3) m or more than m serving cells configured with the DRX operation in one DRX group and for each serving cell n or more than n consecutive indications are received by the MAC layer from the PHY layer. In some implementations of the indication for radio link failure tendency. The parameter n and m mentioned above may be configured via radio resource control (RRC) signaling, downlink control information (DCI), medium-access control element (MAC CE) signaling, or may be predefined.

The indications may be out-of-sync indications, in-sync indications, or some other newly introduced indications for detecting the radio link failure tendency or the radio link resumption tendency. These indications for detecting the tendency of the radio link failure or the radio link resumption tendency may be generated in the PHY layer upon a measurement result of configured reference signals, and these indications may be to indicate the radio link failure tendency for one specific cell or more than one serving cells those are configured with the DRX operation.

As discussed in the illustrative examples below, when monitoring for a set number (n) of consecutive indications regarding a tendency of a beam failure and/or a radio link failure/resumption, user equipment may utilize one or more counters and/or one or more timers. For example, when receiving a first indication from the PHY layer regarding a beam failure tendency or a radio link failure tendency or a radio link resume tendency, the user equipment may increment a counter by one, which may be called as COUNTER X, and start a timer, which may be called Timer X. Upon receipt of each subsequent indication from the PHY layer regarding a beam failure or a radio link failure, the user equipment may increment the COUNTER X by one and restart or start the Timer X, and upon a determination that the Timer X had expired or stopped, reset the COUNTER X to zero.

For another example, when the MAC layer receives a first indication from the PHY layer regarding a beam failure tendency or a radio link failure tendency, the user equipment may increment a COUNTER X by one. Upon receipt of the second indication from the PHY layer regarding the beam failure recovery tendency or radio link failure resumption tendency, the user equipment may reset the COUNTER X to zero.

In some implementations utilizing COUNTER X, the COUNTER X may be maintained by the MAC module per serving cell configured with the DRX operation in one DRX group. In some implementations utilizing COUNTER X, the COUNTER X may be maintained by the MAC module for one specific serving cell configured with the DRX in one DRX group. In some implementations utilizing COUNTER X, the COUNTER X may be maintained by the MAC module for one DRX group.

In some implementations utilizing Timer X, the Timer X may be configured via RRC signaling for each serving cell configured with the DRX operation in one DRX group. In some implementations utilizing Timer X, the Timer X may be configured via RRC signaling for one specific serving cell configured with the DRX operation in one DRX group. In other implementations of Timer X, the Timer X may be configured via RRC signaling for one DRX group.

As also discussed in the illustrative examples below, when user equipment determines to suspend the DRX operation, in some implementations of suspending DRX operation, the user equipment may suspend the DRX operation for one or more serving cells whose beam failure tendency or radio link failure tendency is detected in one DRX group; or the user equipment may suspend the DRX operation for all the serving cells configured with this DRX in one DRX group.

In some implementations of suspending DRX operation, the user equipment may suspend DRX operation for all configured DRX groups or may suspend the DRX group where the beam failure tendency and radio link failure tendency is detected.

In some implementations, a Timer Y may be configured for user equipment to suspend the DRX operation. In some implementations, the Timer Y may be configured per serving cell in one DRX group or per DRX group or for one specific serving cell in one DRX group specifically. In some implementations utilizing Timer Y, the user equipment may start Timer Y when the DRX operation is suspended. In some implementations utilizing Timer Y, the user equipment may stop Timer Y when the beam failure recovery procedure for the serving cell for which the DRX operation is suspended is successfully terminated. In some implementations utilizing Timer Y, the MAC module may resume the DRX operation from suspending status when the Timer Y is stopped or expired.

In some implementations utilizing a shortened DRX cycle, user equipment may apply the short DRX cycle to the subsequent DRX operation for one or more specific serving cells of the DRX group whose beam failure tendency or radio link failure tendency is detected; or the user equipment may apply the subsequent DRX operation for all the serving cells configured with this DRX in one DRX group. In some implementations, the short DRX cycle may be indicated by the parameter shortDRXcycle which is configured to the user equipment via RRC signaling, or MAC CE, or DCI. In some implementations, the short DRX cycle for beam failure tendency case and radio link failure tendency may be either the same or different. In some implementations, if more than one short drx cycle are available concurrently for the subsequent DRX operation for one DRX group, the MAC layer may apply a shortest one to the subsequent DRX operation for one DRX group. In some implementations, if more than one DRX groups are configured to the user equipment, user equipment may apply the short DRX cycle to all the DRX groups. In some implementations, if more than one DRX groups are configured to the user equipment, user equipment may apply the short DRX cycle only to the DRX group where the beam failure tendency for one serving cell of the DRX group, or radio link failure tendency for one serving cell of the DRX group is detected.

In some implementations, a timer drx-shortTimer may be introduced. In some implementations utilizing the drx-shortTimer, The timer drx-shortTimer may be started when the user equipment applies the shortDRXcycle to a subsequent DRX operation for one DRX group. In some implementations utilizing the drx-shortTimer, the timer drx-shortTimer maybe restarted for each time when the MAC layer receives an beam failure tendency indication or radio link failure tendency indication from the PHY layer for a serving cell in a DRX group. In some implementations utilizing the drx-shortTimer, the drx-shortTimer for one DRX group may be stopped by at least one of the following events: (1) The COUNTER X of one specific serving cell of the DRX group is set to 0; (2) m consecutive radio link resumption tendency indications are received from lower layer.

As also discussed in the illustrative examples below, in determining when to resume a suspended DRX operation or return to a DRX cycle of a longer duration from a short DRX cycle for a DRX group, user equipment may utilize one or more counters and/or one or more timers for defining some events.

As also discussed in the illustrative examples below, to detect a failure resumption tendency for a serving cell or to detect a beam failure resumption, the MAC layer may consider at least one of the following events: (1) The COUNTER X associated with the serving cell for which the beam failure tendency is detected is reset to zero. (2) The beam failure recovery procedure for the serving cell is successfully terminated. (3) A timer (i.e Timer Z) is expired or stopped. In some implementations utilizing Timer Z for beam failure resumption tendency detection, the Timer Z may be configured for the serving cell in one DRX group. In some implementations utilizing Timer Z for beam failure resumption tendency detection, the MAC layer may start Timer Z when the beam failure tendency is detected for the associated serving cell. In some implementations utilizing Timer Z for beam failure resumption tendency detection, the MAC layer may restart Timer Z each time the MAC layer receives the beam failure tendency indication from a lower layer such as the PHY layer when the COUNTER X is equal to or larger than n for the associated serving cell.

For example, in the case of a beam failure resumption tendency, the MAC module of the user equipment may resume a suspended DRX operation for one DRX group upon at least one of the following events: (1) There is not any COUNTER X of serving cell(s) configured with the DRX operation in one DRX group that is equal to or larger than n; (2) All triggered beam failure recovery procedures for both the SpCell and SCells in one DRX group are terminated successfully; (3) The triggered beam failure procedure for SpCell configured with the DRX operation in one DRX group is terminated successfully; (4) There is no Timer Z of serving cell(s) in one DRX group that is running; (5) The COUNTER X of one specific serving cell in the DRX group is set to zero; (6) The Timer Z of one specific serving cell in the DRX group is expired or stopped; or (7) Timer Y of the DRX group is expired or stopped.

For another example, in the case of a beam failure resumption tendency, the MAC module of the user equipment may return to the long DRX cycle from the short DRX cycle for one DRX group upon at least one of the following events: (1) The drx-shortTimer is expired or stopped; (2) There is not any COUNTER X of the serving cell(s) configured with the DRX operation in one DRX group those are equal to or lager than the n; (3) There is no Timer Z of serving cell(s) in one DRX group that is running; (4) All triggered beam failure recovery procedures for both the SpCell and SCells in one DRX group are terminated successfully; (5) The triggered beam failure procedure for SpCell configured with the DRX operation in one DRX group is terminated successfully; (6) The COUNTER X of one specific serving cell in the DRX group is set to zero; or (7) The Timer Z of one specific serving cell in the DRX group is expired or stopped.

For example, in the case that the radio link failure resumption tendency, the MAC module of the user equipment may resume a suspended DRX operation for one DRX group upon at least one of the following events: (1) while a T310 timer is running, more than m consecutive radio link resumption tendency indication for one serving cell in the DRX group are received from lower layer. (2) The COUNTER X for one serving cell in the DRX group is set to zero. (3) The Timer Y is expired or stopped. (4) Radio link failure for the serving cell of the DRX group is detected. (5) More than m consecutive radio link resumption tendency indications for the serving cell in the DRX group are received from lower layer; (6) radio link failure for the serving cell of the DRX group is recovered. In some implementations of the above events. The parameter m may be configured via RRC signaling, or MAC CE, or DCI. In some implementation of above events, the T310 may be a timer which may be configured to a user equipment to determine whether the radio link is resumed during the running period. In some implementation of the radio link resumption tendency indication, the indication indicates the radio link is resumed upon the measurement result from the lower layer. In some implementation of the radio link resumption tendency indication, it may be the in-sync indication.

For another example in the case of a radio failure tendency, the MAC module of the user equipment may return to the long DRX cycle from the short DRX cycle for one DRX group upon at least one of the following events: (1) The drx-shortTimer is expired or stopped; (2) The Timer X is expired or stopped; (3) The COUNTER X of the serving cell (i.e SpCell) configured with the DRX operation is set to 0. (4) while T310 is running, m or more than m consecutive radio link resumption tendency indications are received from lower layer. (5) The radio link failure is detected. (6) radio link failure is recovered; (7) m or more than m consecutive radio link resumption tendency indications are received from lower layer. In some implementations of the above events, The parameter m may be configured via RRC signaling, or MAC CE, or DCI. In some implementation of above events, the T310 may be a timer which may be configured to a user equipment to determine whether the radio link is resumed during the running period. In some implementation of the radio link resumption tendency indication, the indication indicates the radio link is resumed upon the measurement result from the lower layer. In some implementation of the radio link resumption tendency indication, it may be the in-sync indication.

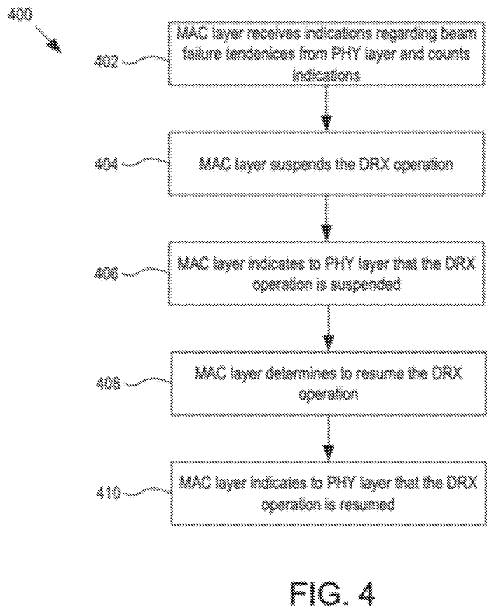

Illustrative examples of these implementations are described below in conjunction with FIG. 4 through FIG. 10.

FIG. 4 is a flow chart of one implementation of a method 400 for user equipment automatically suspending a DRX operation for beam failure recovery. In some implementations, the steps described in conjunction with FIG. 4 occur between a MAC layer and a PHY layer of the user equipment. However, in other implementations, other configurations may be implemented.

The method begins at step 402 with a MAC layer of user equipment receiving from a PHY layer a set number (n) of consecutive beam failure tendency indications for one specific serving cell configured with DRX operation in one DRX group. In some implementations at step 402, COUNTER X is introduced in the MAC layer for counting consecutive received beam failure tendency indication from PHY layer for one specific serving cell in one DRX group, where COUNTER X is equal to or larger than n.

At step 404, the MAC layer suspends a current DRX operation for one DRX group after receiving the set number of consecutive beam failure tendency indications for one specific serving cell or the introduced COUNTER X is equal to or larger than the set number (n). Additionally, at step 404, if a secondary DRX group is configured to the user equipment, the MAC layer may suspend either the DRX group that the failed serving cell belongs to or both DRX groups. At step 406, the MAC layer indicates to the PHY layer that the current DRX operation for the DRX group is suspended.

At step 408, the user equipment determines to resume the DRX operation from suspended status. In some implementations, the user equipment determines to resume the DRX operation when there is not any COUNTER X of the serving cells configured with the DRX operation in the DRX group that is equal to or larger than the set number (n). The user equipment may consider other factors in determining when to resume the DRX operation such as all triggered beam failure recovery procedures for both the SpCell and SCell configured with the DRX operation in one DRX group are terminated successfully, or the triggered beam failure procedure for SpCell configured with the DRX operation is terminated successfully.

At step 410, the MAC layer indicates to the PHY layer that the suspended DRX operation has resumed.

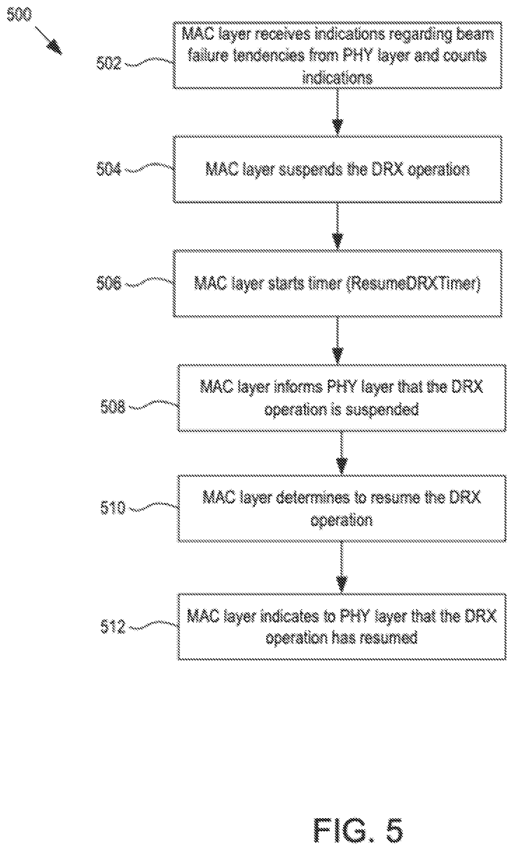

FIG. 5 is a flow chart of another implementation of a method 500 for user equipment automatically suspending a DRX operation of one DRX group for detecting the beam failure tendency. In some implementations, the steps described in conjunction with FIG. 5 occur between a MAC layer and a PHY layer within a UE equipment. However, in other implementations, other configurations may be implemented.

The method begins at step 502 with a MAC layer of user equipment receiving from a PHY layer a set number (n) of consecutive beam failure tendency indications for one specific serving cell configured with DRX operation in one DRX group. In some implementations at step 502, COUNTER X is introduced in MAC layer for calculating the received beam failure tendency indication from PHY layer for a specific serving cell in one DRX group, where COUNTER X is equal to or larger than n.

At step 504, the MAC layer suspends a current DRX operation for one DRX group after receiving the set number (n) of consecutive beam failure indications for one specific serving cell or the COUNTER X is equal to or larger than the set number (n). Additionally, at step 504, if a secondary DRX group is configured to the user equipment, the MAC layer may suspend either the DRX group that the failed serving cell belongs to or both DRX groups.

At step 506, the user equipment starts a pre-configured Timer Y, which may be called ResumeDRXTimer.

At step 508, the MAC layer informs the PHY layer that the DRX operation for the DRX group is suspended,

At step 510, the user equipment determines to resume the DRX operation. In some implementation of the method described in conjunction with FIG. 5, the user equipment determines to resume the DRX operation for the DRX group when the ResumeDRXTimer has expired or stopped.

At step 512, the MAC layer indicates to the PHY layer that the DRX operation for the DRX group has resumed.

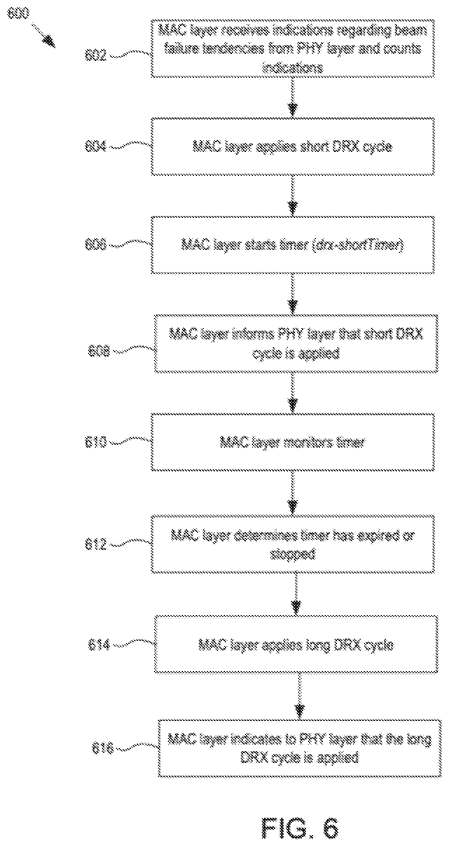

FIG. 6 is a flow chart of one implementation of a method 600 for user equipment automatically utilizing a short DRX period after a beam failure tendency is detected for one DRX group. In some implementations, the steps described in conjunction with FIG. 6 occur between a MAC layer and a PHY layer of user equipment. However, in other implementations, other configurations may be implemented.

The method begins at step 602 with a MAC layer of user equipment receiving from a PHY layer a set number (n) of consecutive beam failure tendency indications for one specific serving cell configured with DRX operation in one DRX group. In some implementations at step 602, COUNTER X is introduced in MAC layer for calculating the received beam failure tendency indication from PHY layer for one specific serving cell in one DRX group, where COUNTER X is equal to or larger than n.

At step 604, the MAC layer applies a short DRX cycle indicated by the drxShortCycle parameter to a subsequent DRX cycle for one DRX group. A short cycle is a DRX cycle that has a reduced duration when compared to a long DRX cycle, as described above.

At step 606, the MAC layer starts/restarts a timer such a drx-shortTimer.

At step 608, the MAC layer informs the PHY layer that the short DRX cycle indicated by the information element drxShortCycle is applied to the DRX group.

At step 610, the MAC layer monitors the drx-shortTimer until at step 612, the MAC layer determines that the timer has expired or stopped. After determining that the drx-shortTimer has expired or stopped, at step 614, the MAC layer applied the long DRX cycle to a subsequent DRX period, and step 616, the MAC layer indicates to the PHY layer that a long DRX cycle is applied.

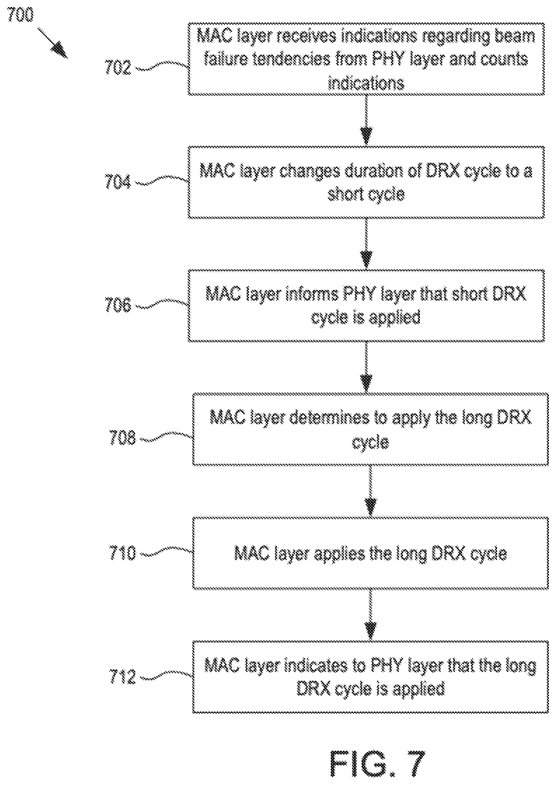

FIG. 7 is a flow chart of another implementation of a method 700 for user equipment automatically utilizing a short DRX period after a beam failure tendency for one DRX group. In some implementations, the steps described in conjunction with FIG. 7 occur between a MAC layer and a PHY layer of user equipment. However, in other implementations, other configurations may be implemented.

The method begins at step 702 with a MAC layer of user equipment receiving from a PHY layer a set number (n) of consecutive beam failure indications for one specific serving cell configured with DRX operation in one DRX group. In some implementations at step 702, COUNTER X is introduced in MAC layer for calculating the received beam failure tendency indication from PHY layer for one specific serving cell configured with DRX operation in one DRX group, where COUNTER X is equal to or larger than n.

At step 704, the MAC layer applies a short DRX cycle indicated by the drxShortCycle parameter to a subsequent DRX cycle for one DRX group. A short cycle is a DRX cycle that has a reduced duration when compared to a long DRX cycle, as described above. At step 706, the MAC layer indicates to the PHY layer that a short DRX cycle for one DRX group is applied.

At step 708, the user equipment determines to apply the long DRX cycle for the subsequent DRX cycle for one DRX group. In some implementations, the user equipment determines to apply the long DRX cycle when there is not any COUNTER X of the serving cells configured with the DRX operation in the DRX group that is equal to or larger than the set number (n). The user equipment may consider other factors in determining when to apply the long DRX cycle such as any triggered beam failure recovery procedures for any of the serving cells configured with the DRX operation in one DRX group are terminated successfully, or the triggered beam failure procedure for SpCell configured with the DRX operation is terminated successfully

At step 710, the MAC layer applies the long DRX cycle for the DRX group, at step 712, the MAC layer indicates to the PHY layer that a long DRX cycle for the DRX group is applied.

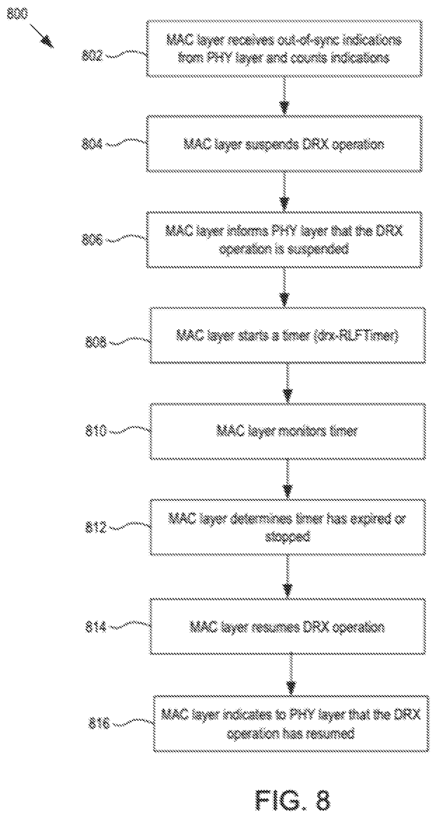

FIG. 8 is a flow chart of one implementation of a method 800 for user equipment automatically suspending a DRX operation after a radio link failure tendency is detected. In some implementations, the steps described in conjunction with FIG. 8 occur between a MAC layer and a PHY layer of user equipment. However, in other implementations, other configurations may be implemented.

The method begins at step 802 with a MAC layer of user equipment receiving from a PHY layer a set number (n) of consecutive radio link failure tendency indication for the SpCell configured with DRX operation in a DRX group. In some implementations at step 802, COUNTER X is introduced in MAC layer for calculating the received radio link failure tendency indication from PHY layer, when COUNTER X is equal to or larger than n.

At step 804, the MAC layer suspends the DRX operation for the DRX group, and at step 806, the MAC layer indicates to the PHY layer that the DRX operation is suspended for the DRX group.

At step 808, the MAC layer starts a Timer Y such as a drx-RLFTimer, as described above. At step 810, the MAC layer monitors the drx-RLFTimer until at step 812, the MAC layer determines that the drx-RLFTimer has expired or stopped. In response, at step 814, the MAC layer resumes the DRX operation from suspended status for the DRX group, and at step 816, the MAC layer indicates to the PHY that DRX operation has resumed.

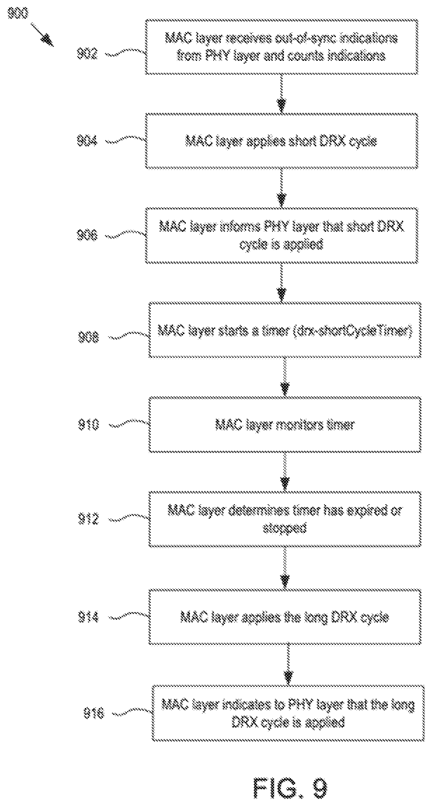

FIG. 9 is a flow chart of one implementation of a method 900 for user equipment automatically utilizing a short DRX period after a radio link failure tendency is detected for a SpCell in one DRX group. In some implementations, the steps described in conjunction with FIG. 9 occur between a MAC layer and a PHY layer of user equipment. However, in other implementations, other configurations may be implemented.

The method begins at step 902 with a MAC layer of user equipment receiving from a PHY layer a set number (n) of consecutive radio link failure tendency indication for a SpCell configured with DRX operation in a DRX group. In some implementations at step 902, COUNTER X is introduced in MAC layer for calculating the received radio link failure tendency indication from PHY layer, when COUNTER X is equal to or larger than n.

At step 904, the MAC layer applies a short DRX cycle indicated by the drxShortCycle parameter to a subsequent DRX cycle for one DRX group. A short cycle is a DRX cycle that has a reduced duration when compared to a long DRX cycle, as described above. At step 906, the MAC layer indicates to the PHY layer that the MAC layer has applied the short DRX cycle.

At step 908, the MAC layer starts a timer such as the drx-shortTimer described above, and at step 910, the MAC layer monitors the drx-shortTimer. At step 912, the MAC layer determines that the drx-shortTimer is expired or stopped.

In response, at step 914, the MAC layer applies the long DRX cycle for the DRX group, and at step 916, the MAC layer indicates to the PHY layer that the DRX cycle has returned to the previous long cycle.

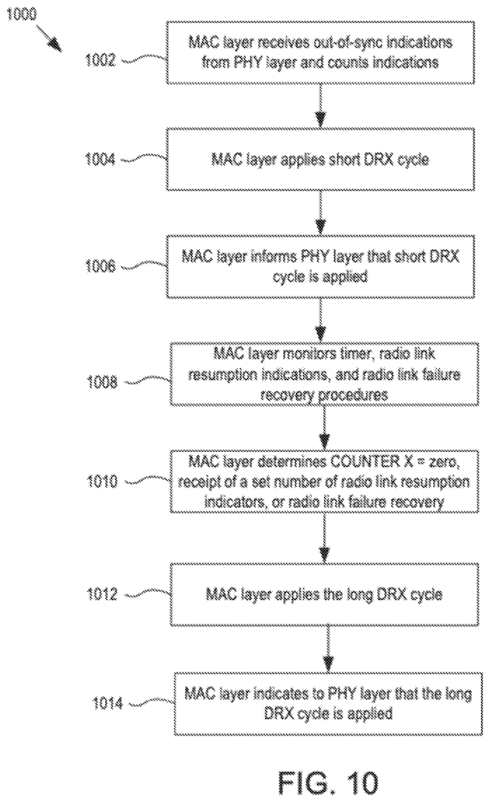

FIG. 10 is a flow chart of another implementation of a method 1000 for user equipment automatically utilizing a short DRX period after a radio link failure tendency is detected for a SpCell in one DRX group. In some implementations, the steps described in conjunction with FIG. 10 occur between a MAC layer and a PHY layer of user equipment. However, in other implementations, other configurations may be implemented.

The method begins at step 1002 with a MAC layer of user equipment receiving from a PHY layer a set number (n) of consecutive radio link failure tendency indication for a SpCell configured with DRX operation in a DRX group. In some implementations at step 1002, COUNTER X is introduced in the MAC layer for calculating the received radio link failure tendency indications from the PHY layer, where COUNTER X is equal to or larger than n.

At step 1004, the MAC layer applies a short DRX cycle indicated by the drxShortCycle parameter to a subsequent DRX cycle for the DRX group that the SpCell belongs to. A short cycle is a DRX cycle that has a reduced duration when compared to a long DRX cycle, as described above.

At step 1006, the MAC layer indicates to the PHY layer that the MAC layer has applied the short DRX cycle.

At step 1008, the MAC layer monitors the COUNTER X described above; monitors whether the MAC layer receives from the PHY layer a set number (m) of consecutive radio link resumption indications for the SpCell, and/or monitors whether the radio link failure is recovered.

At step 1010, the MAC layer determines that at least one of the COUNTER X is set to zero, that that the MAC layer has received the set number (m) consecutive radio link resumption indications for the SpCell, or that the radio link failure has recovered. In response, at step 1012, the MAC layer applies the long DRX cycle for the DRX group, and at step 1014, the MAC layer indicates to the PHY layer that MAC layer has applied the long DRX cycle for the DRX group.

As described above and illustrated in the examples described in conjunction with FIGS. 4-10, the present disclosure provides implementations where user equipment is able to reduce a duration of a DRX cycle when a beam failure or radio link failure is detected in order to more quickly recover from the failure. When user equipment is operating in DRX reception and at least one of a beam failure tendency is detected, a beam failure recovery operation is detected, or a radio link failure tendency is detected, the user equipment may suspend the DRX operation for one DRX group or may decrease a duration of the DRX operations via applying the short DRX cycle for one DRX group, thereby reducing the period of time where the user equipment is in a sleep state. By suspending a currently configured DRX operation or shortening a duration of subsequent DRX cycles, the user equipment is able to more quickly recover from a beam failure or a radio link failure.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
detecting, with a processor of user equipment, a beam failure tendency for a serving cell of one discontinuous reception (DRX) group or a radio link failure tendency for the serving cell of one DRX group; and
adjusting, with the processor, a duration of a subsequent discontinuous reception cycle for the DRX group that the serving cell belong to after the detection of the beam failure tendency or the radio link failure tendency.

2. The method of claim 1, wherein a beam failure tendency for the serving cell in one DRX group is detected based on at least one of:
a value of a counter being equal to or larger than a set value; or
a set number (n) of consecutive indication are received from a lower layer.

3. The method of claim 1, wherein a radio link failure tendency for the serving cell of one DRX group is detected based on at least one of:
a set number (n) consecutive indication are received from a lower layer; or
a value of a counter being equal to or larger than a set value.

4. The method of claim 1, wherein adjusting a duration of a subsequent discontinuous reception cycle comprises:
applying, with the processor, a short DRX cycle for the DRX group.

5. The method of claim 4, further comprising:
detecting, with the processor of user equipment, at least one of a beam failure resumption tendency for all serving cells of the DRX group, beam failure recovery procedures for all serving cells of the DRX group are successfully terminated, a radio link failure resumption tendency for the serving cell of the DRX group, or that a radio link failure is resumed for the serving cell of the DRX group; and
applying, with the processor, a long DRX cycle to the DRX group.

6. The method of claim 5, wherein a beam failure resumption tendency for all serving cells of a DRX group is detected based on at least one of:
no counters of the serving cells in one DRX group is equal to or larger than a set number (n);
a counter of one specific serving cell in one DRX group is set to zero; or
a timer is expired or stopped.

7. The method of claim 5, wherein a radio link resumption tendency for the serving cell of a DRX group is detected based on at least one of:
receipt of at least a set number (n) of radio link resumption tendency indications from a lower layer;
a timer is expired or stopped;
a radio link failure is recovered; or
a value of a counter being set to zero.

8. A wireless communication apparatus, comprising:
a memory operable to store computer-readable instructions; and
a processor circuitry operable to read the computer-readable instructions, the processor circuitry when executing the computer-readable instructions is configured to:
detect a beam failure tendency for a serving cell of one discontinuous reception (DRX) group or a radio link failure tendency for the serving cell of one DRX group; and
adjust a duration of a subsequent discontinuous reception cycle for the DRX group that the serving cell belong to after the detection of the beam failure tendency or the radio link failure tendency.

9. (canceled)

10. A method for wireless communication, comprising:
detecting, with a processor of user equipment, a beam failure tendency for a serving cell of one discontinuous reception (DRX) group or a radio link failure tendency for the serving cell of one DRX group; and
suspending, with the processor, a DRX operation for the DRX group that the serving cell belongs to after the detection of the beam failure tendency or the radio link failure tendency.

11. The method of claim 10, wherein a beam failure tendency for the serving cell in one DRX group is detected based on at least one of:
a value of a counter being equal to or larger than a set value; or
a set number (n) of consecutive indication are received from a lower layer.

12. The method of claim 10, wherein a radio link failure tendency for the serving cell of one DRX group is detected based on at least one of:
a set number (n) consecutive indication are received from a lower layer; or
a value of a counter being equal to or larger than a set value.

13. The method of claim 10, further comprising:
detecting, with the processor of user equipment, at least one of a beam failure resumption tendency for all serving cells of the DRX group, beam failure recovery procedures for all serving cells of the DRX group are successfully terminated, a radio link failure resumption tendency for the serving cell of the DRX group, or that a radio link failure is resumed for the serving cell of the DRX group; and
resuming, with the processor of user equipment, the suspended DRX operation for the DRX group.

14. The method of claim 13, wherein a beam failure resumption tendency for all serving cells of a DRX group is detected based on at least one of:
no counters of the serving cell in one DRX group is equal to or larger than a set number (n);
a counter of one specific serving cell in one DRX group is set to zero; or
a timer is expired or stopped;
a radio link failure is recovered; or
a value of a counter being set to zero.

15. The method of claim 13, wherein a radio link resumption tendency for the serving cell of a DRX group is detected based on at least one of:
receipt of at least a set number (n) of consecutive radio link resumption tendency indications from a lower layer;
a timer is expired or stopped;
a radio link failure is recovered; or
a value of a counter being set to zero.

16. (canceled)

17. (canceled)
